(19) United States
(12) Patent Application Publication
(10) Pub. No.: US 2008/0057893 A1
(43) Pub. Date: Mar. 6, 2008

(54) APPARATUS, SYSTEM AND METHOD OF ESTABLISHING HALF DUPLEX COMMUNICATION IN CELLULAR COMMUNICATION SYSTEMS

(76) Inventor: Jayantharaja Venkateshayya Patla, Bangalore (IN)

Correspondence Address: KYOCERA WIRELESS CORP., P.O. BOX 928289, SAN DIEGO, CA, 92192-8289, US

(21) Appl. No.: 11/468,579

(22) Filed: Aug. 30, 2006

(51) Int. Cl. H04B 1/18

(52) U.S. Cl. 455/187.1

(57) ABSTRACT

A system, method, and cellular communication device that is configured to communicate using half duplex communication over a cellular communication system includes a controller that, in response to a user input, maintains a talk mode for a talk mode duration longer than an input duration of the user input. The user input can be entered through a single user input, such as a switch, of the cellular communication device. The user input may comprise a plurality of activations of the switch within a time period. A user of the cellular communication device can thereby lock the talk mode by double clicking the PTT button. Furthermore, the controller can be configured to detect the user input indicating a request to enter a talk mode of the cellular communication device and to refrain, for a refraining time period longer than an input duration of the user input, from establishing a talk mode of a half duplex communication over the cellular communication system until a communication channel utilized for the half duplex communication is available.

### TECHNICAL FIELD

The invention relates in general to portable communication devices and more specifically to half duplex communication over cellular systems.

### BACKGROUND

Many cellular communication systems provide half duplex communications where a portable communication device can either transmit or receive voice data at any given time. Such communications are typically referred to as “push-to-talk” (PTT) systems since the user pushes a button to place the portable communication device in a talk mode when talking. In conventional systems, the user must continuously depress the push-to-talk button to keep the portable communication device in the talk mode and release the button to listen to others that may wish to talk. When a user is talking on the half duplex communication, it is referred to as holding the floor. Conventional push-to-talk (PTT) half duplex terrestrial communication systems, however, are limited in that the user must continuously depress the PTT button to retain the floor. At the least, this is an inconvenience. For example, if two hands are required for a task while talking, then it is cumbersome to carry the conversation and perform the task at hand at the same time. In addition, a user may attempt to continually depress the PTT button when trying to obtain the floor in order to avoid allowing another user to get the floor. This is cumbersome in most situations.

Accordingly, there is a need for an apparatus, system, and method for communicating using half duplex communication over cellular network without depressing a PTT button continuously.

### SUMMARY

A cellular communication device that is configured to communicate using half duplex communication over a cellular communication system includes a controller that, in response to a user input, maintains a talk mode for a talk mode duration longer than an input duration of the user input. The user input can be entered through a single user input, such as a switch, of the cellular communication device. The user input may comprise a plurality of activations of the switch within a time period. A user of the cellular communication device can thereby lock the talk mode by double clicking the PTT button, for example. Furthermore, the controller can be configured to detect the user input indicating a request to enter a talk mode of the cellular communication device and to refrain, for a refraining time period longer than an input duration of the user input, from establishing a talk mode of a half duplex communication over the cellular communication system until a communication channel utilized for the half duplex communication is available.

### BRIEF DESCRIPTION OF THE DRAWINGS

FIG. 1 is a block diagram of cellular communication system configured to support half duplex communication in accordance with the exemplary embodiment.

FIG. 2 is flow chart of a method of managing half duplex communication in accordance with the exemplary embodiment.

FIG. 3 is a flow chart of an exemplary method of detecting a user input indicating an activation of a PTT lock function.

### DETAILED DESCRIPTION

In an exemplary embodiment, a cellular communication device is configured to maintain a talk mode of a half duplex call over a cellular communication system for a talk mode duration longer than an input duration of a user input. The user input can be provided to the cellular communication device through various mechanisms resulting in a lock of a PTT function of the communication device. In the exemplary embodiment, the cellular communication device is further configured to detect the user input indicating a request to enter a talk mode of the cellular communication device and to refrain, for a refraining time period longer than an input duration of the user input, from establishing a talk mode of a half duplex communication over the cellular communication system until a communication channel utilized for the half duplex communication is available.

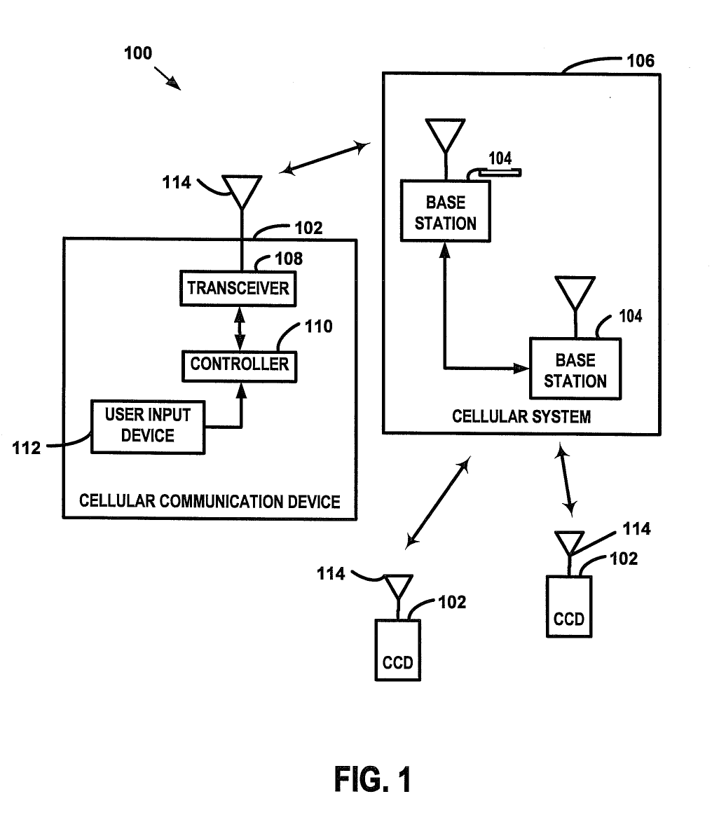

FIG. 1 is a block diagram of a cellular communication system 100 configured to support half duplex communication in accordance with an exemplary embodiment of the invention. In the exemplary embodiment, a group of cellular communication devices 102 communicate with each other through one or more base stations 104 forming a cellular network 106 using half duplex communication. Based on a user input, a cellular communication device 102 maintains a talk mode without the requirement to have a PTT button continuously depressed during the talk mode. It is known to those skilled in the art that the cellular network 106 may include other components, for example, public switched telephone network (PSTN) and mobile switching center (MSC) (not shown) for providing communication between the cellular communication devices (CCD) 102. In a half duplex communication that is referred to as push-to-talk (PTT), a user can make direct one-to-one or one-to-many voice communications over any packet data network. In conventional systems, the PTT over cellular calls are established by depressing and holding the PTT button on the CCD 102.

In PTT over cellular calls, the ability to communicate to other CCD 102 is determined by the status of the “floor”. When a CCD 102 “has the floor”, a half duplex channel is provided to the CCD 102 for transmitting voice signals to other CCDs 102 designated as recipients of the transmission. In the half duplex communication, a talk mode communication is only established when a communication channel utilized for the half duplex communication is available by the cellular network 106. Therefore, a user in a conventional system must depress the PTT button at the appropriate time in order to obtain the floor. In the exemplary embodiment, however, the user can provide an input allowing the user's CCD 102 to obtain the floor when the channel becomes available, eliminating the need to for the user to wait for the floor or to continually depress the PTT in order to obtain the floor as soon as it is available.

In the exemplary embodiment, the CCD 102 comprises a controller 110 connected to a transceiver 108 and to a user input device 112. The transceiver 108 communicates with the cellular network 106 through an antenna 114. The controller 110 is configured to detect a user input from the user input device 112 and, in response to the user input, perform one of at least two PTT functions depending on the status of the floor. When the PTT lock user input is entered and the floor is available, the controller 100 establishes a talk mode for the CCD 102. If however, the floor is not available, the PTT lock user input is interpreted as a request to enter a talk mode when the floor becomes available. The controller 110 refrains from establishing the talk mode until a communication channel is available. In the exemplary embodiment, the controller 110 upon detecting the PTT lock user input, automatically locks one of the above-mentioned desired functions eliminating the need for the user to continuously depress a button on the CCD 102. Therefore, the user need not depress and hold a PTT button to maintain the talk mode or to try to obtain the floor for transmission.

The user input device 112 may include any of numerous input devices such as, for example, a push button, a keypad button on a cellular phone, a touch pad button on a display of the CCD 102, or voice-activated input device. In the exemplary embodiment, the user input device 112 is a PTT button that includes a switch (not shown) that is activated in response to the user input. The user can depress and hold the PTT to maintain a talk mode as in conventional systems or may invoke the PTT lock feature by depressing the PTT button in accordance with the PTT lock user input. In the exemplary embodiment, the PTT lock user input comprises a plurality of activations of the switch within a PTT lock time period. For example, PTT lock user input may be two activations of a single PTT button within the PTT lock time period similar to a “double click” entered through a computer mouse. The controller 110 detects the switch activations within the PTT lock time period to identify the user input as a PTT lock user input. In response, the controller 110 establishes and maintains the talk mode when the floor is available. In some circumstances, the user input to request the floor when unavailable may be different than the user input for the PTT lock feature. According to the exemplary embodiment, the talk mode is maintained for a talk mode duration longer than the input duration of the user input. The talk mode duration can be based on a talk mode termination event such as another activation of the switch by the user indicating to the controller 110 that the talk mode must be halted. In some circumstances, the talk mode duration is based on a programmed time duration. Exampled of programmed time durations include durations of a few seconds to several minutes. The programmed time duration may be determined based on any of numerous factors such the number of users in a call group, the types of conversations within the call group, and historical data of talk mode durations. Also, in other circumstances, the talk mode duration is based on a detection of a low audio signal where an audio input signal level remains below a threshold for a low-audio time period. For example, when the user that has the floor stops talking, the controller 110 detects a low audio signal for a minimum inactive time period and releases the floor by terminating the talk mode.

In some circumstances, the controller 110 may detect a user input when the floor is utilized by some other user and therefore, a half duplex communication channel may not be available to establish a talk mode. In that case, the controller 110 processes the user input as an indication of the request to enter a talk mode. The controller 110 communicates with the cellular network 106 via the transceiver 108 and monitors the availability of a half duplex channel for the talk mode. While monitoring the availability of the half duplex communication channel, the controller 110 refrains from establishing a talk mode for a refraining time period. In the exemplary embodiment, the refraining time period may be longer than the input duration of the user input. For example, the user can double click the PTT button in a few tenths of second but the controller may refrain from establishing the talk mode and obtaining the floor for several minutes while the floor is retained by another user. In some circumstances, the refraining time period can be a preset length of time or it can be a time period until the half duplex channel becomes available.

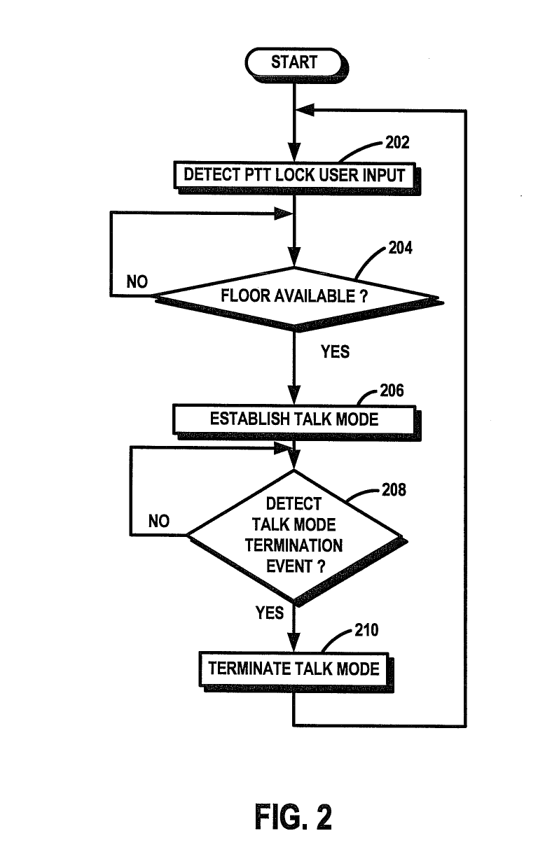

FIG. 2 is flow chart of a method of managing half duplex communication in accordance with the exemplary embodiment. Although the method may be performed by any combination of hardware, software and/or firmware or in any of numerous devices, the method is executed by the controller 110 in the cellular communication device 102 in the exemplary embodiment. Code executed in the controller 110 performs the calculation, decision, detection and signal generation functions to manage the components and entities within the cellular communication device 102.

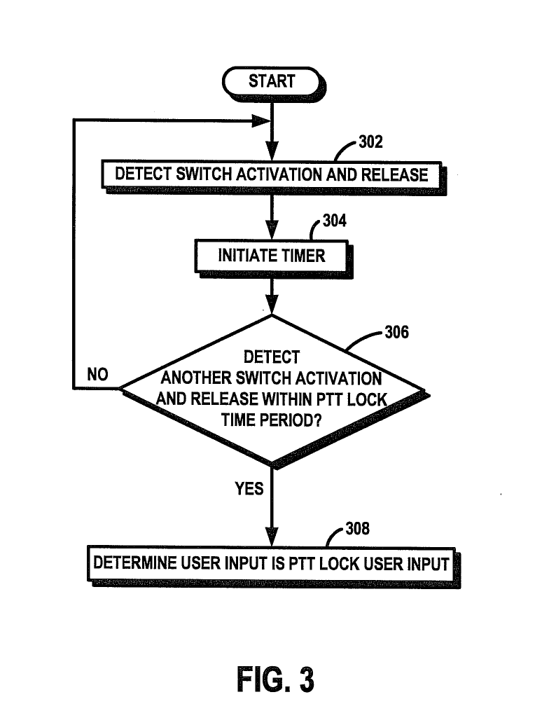

At step 202, the controller 110 detects a PTT lock user input indicating the PTT function should be locked. In the exemplary embodiment, the user depresses the user input device 112 a number of times causing a plurality of activations of the switch within the PTT lock time period. The user may double click the PTT button, for example. The controller 110 detects the PTT lock user input from the activations of the switch. An exemplary technique for detecting the PTT lock user input is discussed below with reference to FIG. 3.

At step 204, the controller 110 determines if the half duplex channel is available. If the half duplex channel is not available, then the controller 110 continues to monitor the availability of the half duplex channel. If the half duplex channel is available, then the method proceeds to step 206.

At step 206, the controller 110 establishes the talk mode for the CCD 102. In accordance with the protocols and procedures of the CCD 102 and the cellular system 106, the controller activates the transmitter in the transceiver 108 and establishes the talk mode. The user of the CCD 102, therefore, can speak to the other members of the half duplex call without continually depressing the PTT button.

At step 208, it is determined whether a talk mode termination event has occurred. The talk mode termination event may be any of numerous events such as, for example, a user input, expiration of time period, a detection of a lack of an audio signal. In the exemplary embodiment, the talk mode termination event is a detection of another activation of the switch or a detection of a lack of audio signal for a maximum no-audio time period. The lack of audio signal is detected when an audio signal at the microphone of the CCD 102 remains below a minimum audio threshold for a maximum no-audio time period. The controller 110, therefore, maintains the talk mode for a talk mode duration until it detects a talk mode termination event. If controller 110 detects the talk mode disable event, then it proceeds to step 210.

At step 210, the controller 110 terminates the talk mode. The transmitter is deactivated and the talk mode is stopped in accordance with the procedure and protocols of the CCD 102 and the cellular system 106. The method proceeds to step 202 where the controller 110 waits until another user input is detected. Therefore, the method maintains, in response to a user input, a talk mode of a half duplex communication over a cellular communication system 100 for a talk mode duration longer than an input duration of the user input. By establishing a PTT lock, the user no longer needs to continuously depress the PTT button. In conventional systems, the PTT button must remain depressed during the entire length of the talk mode in contrast to the exemplary embodiment where the user input duration is shorter than the duration of the talk mode.

When the half duplex channel is unavailable, steps 202, 204 and 206 provide an exemplary method for refraining to establishing a talk mode. At step 202, the controller detects the user input indicating a request to enter the talk mode. At step 204, the controller determines the channel is not available and continues to monitor the channel indicating by the return to block 204 until the controller 110 detects that the channel is available. Therefore, the controller 110 refrains, for a refraining time period longer than an input duration of the user input, from establishing the talk mode until a communication channel utilized for the half duplex communication is available.

FIG. 3 is a flow chart of an exemplary method of detecting a user input indicating an activation of a PTT lock function. The method of FIG. 3, therefore, provides an exemplary method of performing step 202 of FIG. 2 discussed above.

At step 302, it is determined whether the switch has been activated and released. In the exemplary embodiment, the controller 110 detects an activation and release of the switch and starts a timer at step 304.

At step 306, it is determined whether the switch has been activated and released a second time within the PTT lock time period. In the exemplary embodiment, the controller 110 determines whether there is a second activation of the switch within a maximum time period. If no second activation is detected, the method returns to step 302 and the controller 110 processes the first activation as an event other than a PTT lock user input. If a second activation is detected within the PTT lock time period, the method proceeds to step 308.

At step 308, the controller 110 identifies the user input as a PTT lock user input.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A cellular communication device configured to communicate using half duplex communication over a cellular communication system, the cellular communication device comprising:
a controller configured to maintain, in response to a user input, a talk mode of a half duplex communication over the cellular communication system for a talk mode duration longer than an input duration of the user input.

2. The cellular communication device of claim 1 further comprising a switch connected to the controller, the user input comprising a plurality of activations of the switch within a time period.

3. The cellular communication device of claim 2, wherein the talk mode duration is based on a talk mode termination event.

4. The cellular communication device of claim 3, wherein the talk mode termination event comprises another activation of the switch.

5. The cellular communication device of claim 1, wherein the talk mode duration is based on a preset time duration.

6. The cellular communication device of claim 1, wherein the talk mode duration is based on a detection of a low audio signal where an audio input signal level remains below a threshold for at least a low-audio time period.

7. The cellular communication device of claim 1, wherein the controller is further configured to refrain from establishing the talk mode until a communication channel utilized for the half duplex communication is available.

8. A cellular communication device configured to communicate using half duplex communication over a cellular communication system, the cellular communication device comprising:
a controller configured to detect a user input indicating a request to enter a talk mode of the cellular communication device and to refrain, for a refraining time period longer than an input duration of the user input, from establishing a talk mode of a half duplex communication over the cellular communication system until a communication channel utilized for the half duplex communication is available.

9. The cellular communication device of claim 8, further comprising a switch connected to the controller, the user input comprising a plurality of activations of the switch within a push-to-talk (PTT) lock time period.

10. The cellular communication device of claim 9, wherein the controller is further configured to, when the communication channel is available, establish the talk mode of the half duplex communication over the cellular communication system and maintain the talk mode for a talk mode duration longer than the input duration of the user input until a talk mode termination event is detected.

11. The cellular communication device of claim 10, wherein the talk mode termination event comprises another activation of the switch.

12. The cellular communication device of claim 11, wherein the talk mode duration is based on a programmed time duration.

13. The cellular communication device of claim 12, wherein the talk mode duration is based on a detection of a low audio signal where an audio input signal level remains below a threshold for at least a low-audio time period.

14. A method in a cellular communication device configured to communicate using half duplex communication over a cellular communication system, the method comprising:
detecting a user input; and
maintaining a talk mode of a half duplex communication over the cellular communication system for a talk mode duration longer than an input duration of the user input.

15. The method of claim 14, wherein the maintaining comprises maintaining the talk mode until a talk mode termination event is detected.

16. The method of claim 14, wherein the detecting a user input comprises:
detecting a plurality of activations of a switch of the cellular communication device within a push-to-talk lock time period.

17. The method of claim 15, wherein the talk mode termination event comprises:
detecting an audio input signal level remaining below a threshold for a low-audio time period.

18. A method in a cellular communication device configured to communicate using half duplex communication over a cellular communication system, the method comprising the steps of:
detecting a user input indicating a request to enter a talk mode of a half duplex communication over the cellular communication system; and
refraining, for a refraining time period longer than an input duration of the user input, from establishing the talk mode until a communication channel utilized for the half duplex communication is available.

19. The method of claim 18, wherein the detecting the user input comprises detecting a plurality of activations of a switch within a push to talk lock time period.

20. The method of claim 19, further comprising:
establishing a talk mode of the half duplex communication over the cellular communication system when the communication channel is available; and
disabling the talk mode when a talk mode termination event is detected.

21. The method of claim 20, wherein the talk mode termination event comprises:
detecting another activation of the switch.

22. The method of claim 20, wherein the talk mode termination event comprises:
detecting an audio input signal level remaining below a threshold for a low-audio time period.
